(19) United States
(12) Patent Application Publication
(10) Pub. No.: US 2025/0350565 A1
(43) Pub. Date: Nov. 13, 2025

(54) DATA PACKET COALESCING WITH HEADER PIPELINING

(71) Applicant: QUALCOMM INCORPORATED, San Diego, CA (US)

(72) Inventors: Ujjwal LNU, Muzaffarpur (IN); Srikanth RAPOLU, Hyderbad (IN); Sreedhar LAKKARAJU, Hyderabad (IN); Panyala Chandra SHEKAR REDDY, Hyderabad (IN)

(21) Appl. No.: 18/662,951

(22) Filed: May 13, 2024

(51) Int. Cl. H04L 47/41; H04L 45/00; H04L 47/129

(52) U.S. Cl. CPC H04L 47/41; H04L 45/566; H04L 47/129

(57) ABSTRACT

Data may be transmitted from a first device to a second device over a data link by transmitting header information for a coalesced data packet before aggregation of data into the coalesced data packet has been completed. The coalesced data packet may aggregate multiple data packets from a data source into a payload. As the second device may receive the header information before it receives the coalesced data packet, the second device may process the received header information without waiting to receive the coalesced data packet.

### DESCRIPTION OF THE RELATED ART

A computing device may include a bus or other data link through which various subsystems or other components may communicate with each other. The components may include integrated circuit chips or dies, as well as co-packaged dies, sometimes referred to as “chiplets.” The data link may be configured in accordance with a high-speed bus protocol, such as, for example, Peripheral Component Interconnect express (PCIe). The data link may operate in accordance with packet-based communication protocols, such as Transport Control Protocol (TCP) and Internet Protocol (IP). At the transmitting or sending end of the data link, a component may form the data into units known as packets, each containing one or more headers and a payload, and transmit the packets over the data link. At the receiving end of the data link, a component (e.g., an operating system's TCP/IP protocol stack) may use information contained in each packet's header to facilitate reading the data (payload) from that packet, to route the packet to a further destination, or other purposes.

Data packet coalescing is a technique in which a component that is sending packets over a data link may aggregate or coalesce the data (payloads) of multiple data packets into a single “coalesced packet.” For example, multiple TCP/IP packets may be coalesced together into a single coalesced packet having only one TCP/IP header. All of a coalesced packet's data (payload) may share the same information in the coalesced packet's header. A component that is receiving the packets may process coalesced packets faster than non-coalesced packets because the component needs to process fewer headers for the same amount of payload. While data packet coalescing may enhance data link performance by reducing processing overhead, it may be desirable to provide further enhancements to data packet coalescing.

### SUMMARY OF THE DISCLOSURE

Systems, methods, and other examples of communicating data over a data link are disclosed.

An exemplary method for communicating data from a first device to a second device over a data link may include receiving, by the first device, a plurality of data packets from a data source associated with the first device. The method may also include providing, by the first device, header information based on at least one data packet of the plurality of data packets. The method may further include sending, by the first device, the header information to the second device over the data link. The method may still further include providing a coalesced data packet, including aggregating the plurality of data packets into a payload of the coalesced data packet. The method may yet further include sending, by the first device, the coalesced data packet to the second device over the data link. Sending the header information may be performed before aggregating the coalesced data packet is completed.

An exemplary system for communicating data from a first device to a second device over a data link may include a data packet buffer in the first device, header processing circuitry in the first device, and aggregator circuitry in the first device. The data packet buffer may be configured to receive a plurality of data packets from a data source associated with the first device. The header processing circuitry may be configured to provide header information based on at least one data packet of the plurality of data packets and further configured to send the header information to the second device over the data link. The aggregator circuitry may be configured to provide a coalesced data packet. The aggregator circuitry may be configured to aggregate the plurality of data packets into a payload of the coalesced data packet and to send the coalesced data packet to the second device over the data link. The header processing circuitry may be configured to send the header information before the aggregator circuitry completes aggregating the coalesced data packet.

Another exemplary system for communicating data from a first device to a second device over a data link may include coalescing circuitry in the first device and de-coalescing circuitry in the second device. The coalescing circuitry may be configured to aggregate a plurality of data packets into a payload of a coalesced data packet, to send a Transport Control Protocol (TCP) header of the coalesced data packet to the second device over the data link, and to send the coalesced data packet to the second device over the data link after sending the TCP header. The de-coalescing circuitry may be configured to process the TCP header before receiving the coalesced data packet from the first device and to de-aggregate the payload of the coalesced data packet using the TCP header.

### BRIEF DESCRIPTION OF THE DRAWINGS

In the Figures, like reference numerals refer to like parts throughout the various views unless otherwise indicated. For reference numerals with letter character designations such as “101A” or “101B”, the letter character designations may differentiate two like parts or elements present in the same Figure. Letter character designations for reference numerals may be omitted when it is intended that a reference numeral encompass all parts having the same reference numeral in all Figures.

FIG. 1 is a block diagram of a system for communicating data from a first device to a second device over a data link, in accordance with exemplary embodiments.

FIG. 2 is a block diagram of another a system for communicating data from a first device to a second device over a data link, accordance with exemplary embodiments.

FIG. 3 is a timing diagram illustrating sending a Transport Control Protocol (TCP) header and Internet Protocol (IP) header before aggregation of data into a coalesced data packet is completed, accordance with exemplary embodiments.

FIG. 4 is a flow diagram illustrating a method for communicating data from a first device to a second device over a data link, in accordance with exemplary embodiments.

FIG. 5 is a data diagram of a coalesced data packet, in accordance with exemplary embodiments.

FIG. 6 is similar to FIG. 5, further showing a coalescing header of the coalesced data packet, in accordance with exemplary embodiments.

FIG. 7 illustrates aspects of a coalesced data packet with coalescing header, in accordance with exemplary embodiments.

FIG. 8 is a flow diagram illustrating a method for adjusting a coalesced data packet size, in accordance with exemplary embodiments.

FIG. 9 is a block diagram of a computing device in which systems, methods and other examples of communicating data from a first device to a second device over a data link may be provided, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

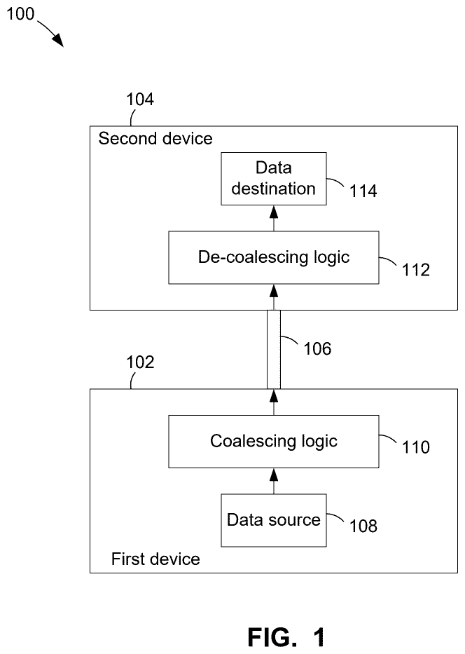

As shown in FIG. 1, in an illustrative or exemplary embodiment a system 100 may include a first device 102 and a second device 104 interconnected to each other by a data communication link 106. The first device 102 and second device 104 may be, for example, integrated circuit chips or dies. The data communication link 106 may implement any data interconnect (e.g., bus) protocol or specification, such as, for example, Peripheral Component Interconnect express (PCIe), Universal Serial Bus (USB), etc.

The system 100 may be included in a computing device (not shown), which may be of any type. For example, the system 100 may be included in a desktop or laptop computer, a datacenter processing unit, a portable computing device such as a smartphone, an automotive device, an Internet of Things (IoT) device, or a wearable device such as a wristwatch-style device, eyewear, a headset, etc.

The first device 102 may include a data source 108 and coalescing logic 110. The data source 102 may be, for example, a processor, processing subsystem, sensor subsystem, transceiver subsystem, or any other device component, subsystem, etc., which provides or outputs data as a result of its operation. The data source 102 may provide the data in packetized form. Although the first device 102 may have multiple data sources, only the data source 108 is shown for purposes of clarity. The coalescing logic 110 may comprise circuitry that is configured to aggregate or coalesce the data (payloads) of multiple data packets received from the data source 102 into a single “coalesced packet.” The coalescing logic 110 may also be configured to initiate the transmission of such coalesced data packets to the second device 104 over the data communication link 106. Although the terms “aggregating” and “coalescing” may sometimes be used interchangeably, the term “aggregating” may be used herein to refer to operations involving payload data, while the term “coalescing” may be used herein to refer more broadly to forming a coalesced data packet.

The second device 104 may include de-coalescing logic 112 and a data destination 114. The data destination 114 may be for example, a processor, processing subsystem, or any device component, subsystem, etc., which processes or otherwise uses the data received from the first device 102. The de-coalescing logic 112 may comprise circuitry that is configured to de-aggregate or extract the data from the payload of a coalesced data packet. As described below, information contained in one or more headers of a coalesced data packet may be used in de-aggregating data from the payload of a coalesced data packet.

As also described below, in accordance with a feature of the solutions described herein, the first device 102 may send such header information to the second device 104 before the first device 102 completes aggregating the data packets associated with that header information. Sending the header information ahead of the coalesced data packet may enable the second device 104 to complete processing the header information early, so that the second device 104 may begin de-aggregating the data from the coalesced data packet as soon as the second device 104 receives the coalesced data packet.

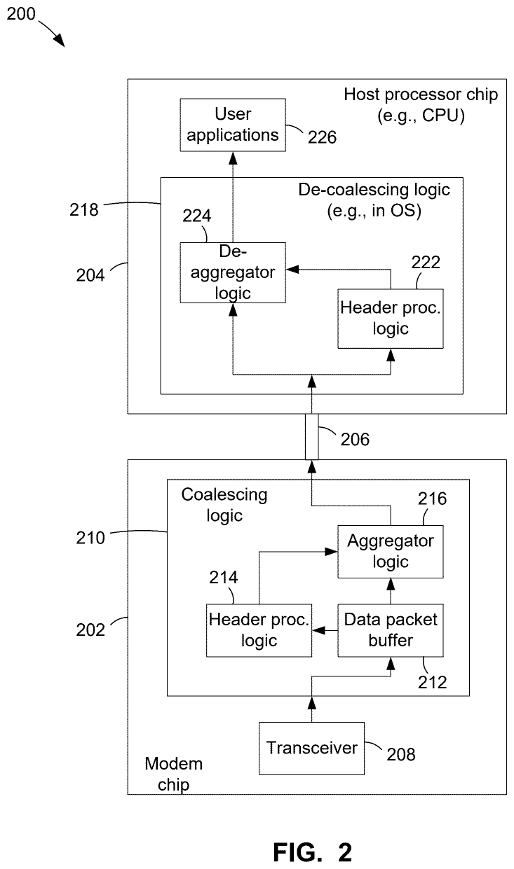

In FIG. 2, a system 200 is shown that may be an example of the above-described system 100 (FIG. 1). In the illustrated example, a transceiver or modem chip 202 and a host processor chip 204 are interconnected by a data communication link 206, such as, for example, a PCIe bus. Although not shown, the modem chip 202 and host processor chip 204 may be included in a portable communication device, such as, for example, a smartphone, in which the modem chip 202 provides wireless data connectivity. Accordingly, the modem chip 202 may include a wireless or radio frequency (RF) transceiver component 208. For purposes of clarity, antennas, RF front end circuitry, or other details associated with wireless reception of data by the transceiver component 208 are not shown.

The modem chip 202 may also include packet coalescing logic 210. The packet coalescing logic 210 may comprise circuitry configured to receive data from the RF transceiver component 208. The transceiver component 208 or associated circuitry (not shown) may be configured to packetize the data it provides to the packet coalescing logic 210. That is, the RF transceiver component or such other circuitry may form the received data into data packets. Examples of data packet formats are described below. Nevertheless, it may be noted here that in the exemplary system 200 the packet format may include a Transport Control Protocol (TCP) header and an Internet Protocol (IP) header.

The coalescing logic 210 may include a data packet buffer 212, header processing logic 214, and aggregator logic 216. The data packet buffer 212 may comprise circuitry configured to receive data packets from the RF transceiver component 208. The header processing logic 214 may comprise circuitry configured to provide header information based on one of the data packets. This header information may be common to all of the data packets that the coalescing logic 210 coalesces into a coalesced data packet. For example, the data packet on which the header information is based may be the first data packet that the coalescing logic 210 receives from the transceiver component 208 from among all of the (N) data packets that the coalescing logic 210 is to coalesce into a coalesced data packet. Information contained in either or both of a TCP header and IP header may be an example of header information, as a TCP header and IP header may contain information common to all of the data packets that are to be coalesced together into a coalesced data packet. This header information may also be referred to as “first” header information, as in some examples there may be additional (e.g., second, etc.) header information. In such examples, the terms “first,” “second,” etc., are used for convenience to distinguish the headers from one another and not to signify any order or sequence.

The aggregator logic 216 may comprise circuitry configured to provide the coalesced data packet. The aggregator logic 216 may be configured to aggregate a number (N) of data packets into a payload of the coalesced data packet. The number N may be provided in any manner. For example, the number N may be fixed or constant, i.e., may be the same for every coalesced data packet. Alternatively, as described below with regard to another feature of the solutions set forth herein, the number N may be variable or adjustable, i.e., may differ among coalesced data packets. The aggregator logic 216 may be further configured to send the coalesced data packet to the host processor chip 204 over the data communication link 206. Nevertheless, the header processing logic 214 may be configured to send the above-described first header information to the host processor chip 204 over the data communication link 206 before the aggregator logic 216 completes the above-described aggregation of the N data packets. Sending such header information in advance of the coalesced data packet to which it relates may provide advantages or benefits, as described below.

The host processor chip 204 may comprise, for example, a central processing unit (CPU). The host processor chip 204 may include de-coalescing logic 218. The de-coalescing logic 218 may be, for example, a CPU feature configured by software, such as operating system (OS) software. That is, the de-coalescing described herein may be an OS feature, i.e., performed under control of an OS. Nevertheless, in other examples such de-coalescing logic may be hardware (circuitry).

The de-coalescing logic 218 may include header processing logic 222 and de-aggregator logic 224. The header processing logic 222 may be configured to process the above-described first header (e.g., TCP/IP) information that is received from the modem chip 202 over the data communication link 206. For example, the header processing logic 222 may be configured to extract information such as source and destination addresses, port numbers, control flags, and checksums. The extracted information may be used by the receiving application to ensure reliable data delivery and maintain the communication session. The de-aggregator logic 224 may be configured to receive the coalesced data packet from the modem chip 202 over the data communication link 206. The de-aggregator logic 224 may be configured to use the first header information in de-aggregating or extracting the data from the payload of the coalesced data packet. As the de-aggregator logic 224 has already received and processed the header information by the time the de-aggregator logic 224 has received the coalesced data packet, the de-aggregator logic 224 is not delayed in its de-aggregation task by having to process the first header information before de-aggregating the coalesced data packet. After de-coalescing a coalesced data packet, the de-coalescing logic 220 may provide the extracted data to a destination, such as one or more user applications 226 executing on the host processor chip 204.

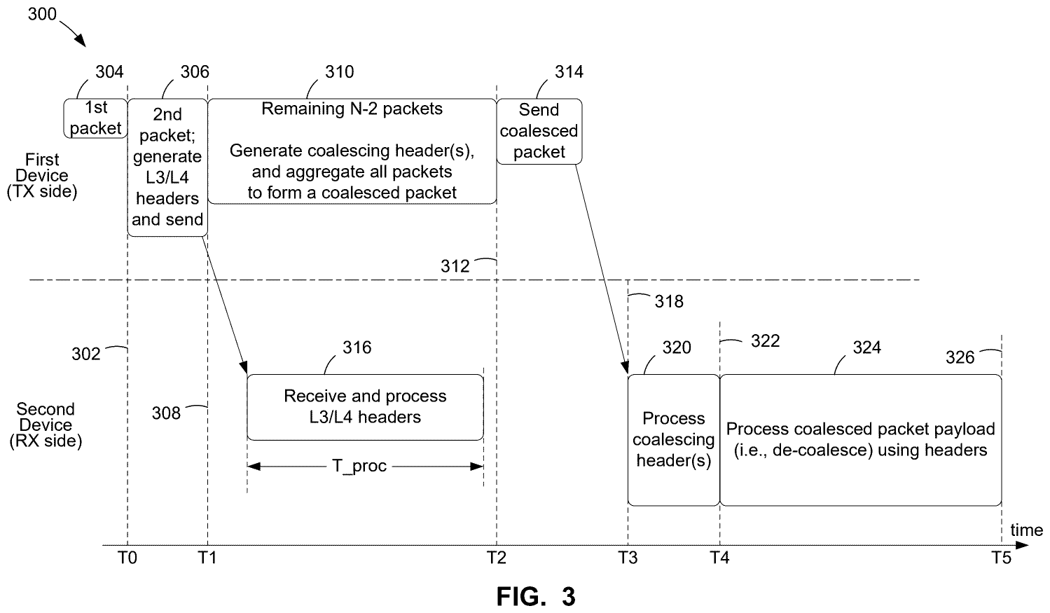

In FIG. 3, a timing diagram 300 may illustrate an example of operation of the above-described system 200 (FIG. 2) or system 100 (FIG. 1). At a time 302 (TO), a first device on a sending or transmitting (TX) side of a data communication link may have received from a data source a first data packet 304 of a number (N) of data packets to be coalesced. Between the time 302 (T0) and a time 308 (T1), the first device may perform operations 306 that include generating the IP header (also referred to as a level_3 or L3 header) and the TCP header (also referred to as a level_4 or L4 header) based on the first data packet 304. The operations 306 may also include receiving one or more additional data packets, such as a second data packet, of the N data packets to be coalesced, which may occur concurrently with generating the TCP and IP headers.

At the time 308 (T1), i.e., when the first device has completed generating the TCP and IP headers, the first device may send or transmit the TCP and IP headers to a second device on a receiving (RX) side of the data communication link. Meanwhile, the first device may perform operations 310 that include continuing to receive data packets from the data source. In the illustrated example, the first device has received the second data packet of the N data packets by time 308 (T1) and then begins receiving the remaining N−2 data packets at time 308 (T1). The operations 310 may also include generating one or more coalescing headers. As described below, a coalescing header may comprise information that may be used on the RX side to de-coalesce the data. The operations 310 may further include aggregating all of the data from the N data packets received from the data source into a coalesced packet. The coalesced packet may include the one or more coalescing headers and other headers, as described below.

When the first device has completed forming the coalesced data packet at time 312 (T2), the first device may begin the sending operation 314 in which the coalesced data packet is sent or transmitted to the second device over the data communication link. In the illustrated example, by the time 312 (T2) that the first device begins the coalesced data packet sending operation 314, the second device has already completed the operations 316 of receiving and processing the TCP and IP headers. As noted above, this processing of TCP/IP headers may include extracting information such as source and destination addresses, port numbers, control flags, and checksums. The second device does not need to wait until it has completely received the coalesced data packet at time 318 (T3) to process the TCP and IP headers. Rather, the second device can begin processing the TCP and IP headers as soon as they are received. The header receiving and processing operations 316 take some amount of time (T_proc), and this time can be concurrent with the time (T2-T1) during which the packet aggregating operations 310 are performed. Performing the header processing operations 316 in the second device concurrently with the packet aggregating operations 310 in the first device is a form of pipelining, which may improve end-to-end processing time.

When the second device has received the coalesced data packet at time 318 (T3), the second device may perform any operations 320 that may be preliminary to de-coalescing, such as processing one or more other headers (e.g., coalescing header) that may be included in the coalesced data packet. An example of a coalescing header is described below. Having completed processing the coalescing header at time 322 (T4), the second device may then use the information in the coalescing header and the L3 and L4 headers to perform the de-coalescing operation 324. In the illustrated example, the de-coalescing operation 324 is completed at time 326 (T5). Note that the end-to-end processing time, T5-T0, would be greater by an amount equal to T_proc if the header processing operations 316 in the second device were not performed until the second device had received the coalesced data packet.

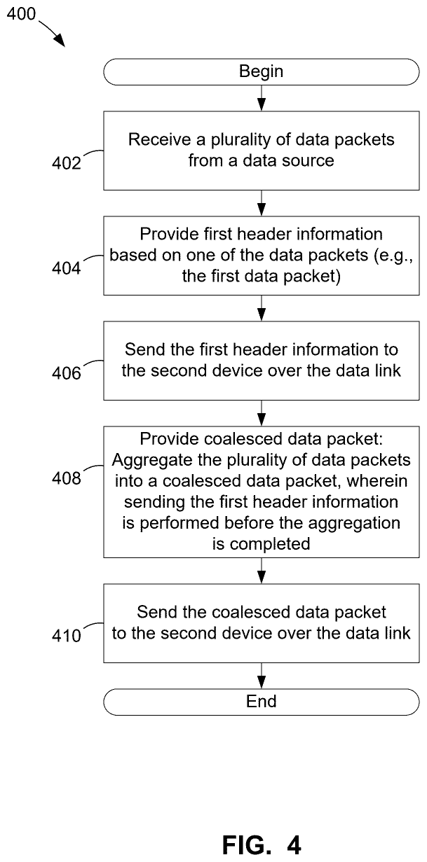

In FIG. 4, a method 400 for communicating data from a first device to a second device over a data link is illustrated in flow diagram form. As indicated by block 402, the method 400 may include receiving, by the first device, a plurality of data packets from a data source associated with the first device. As indicated by block 404, the method 400 may also include providing, by the first device, first header information based on at least one of the data packets of the plurality of data packets. As indicated by block 406, the method 400 may further include sending, by the first device, the first header information to the second device over the data link. As indicated by block 408, the method 400 may still further include providing, by the first device, a coalesced data packet. Providing the coalesced data packet may include aggregating the plurality of data packets into a payload of the coalesced data packet, wherein sending the first header information (block 406) is completed before the aggregation is completed. As indicated by block 410, the method 400 may yet further include sending, by the first device, the coalesced data packet to the second device over the data link.

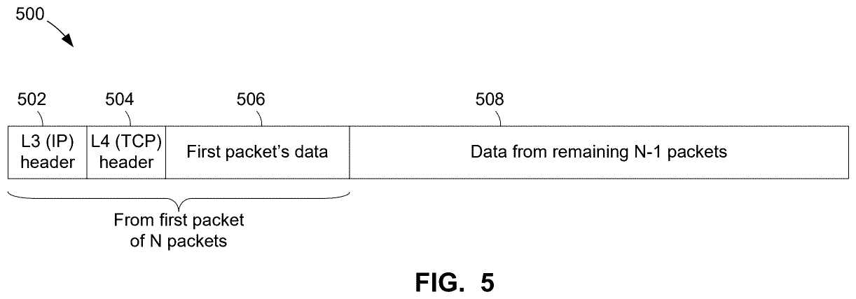

As shown in FIG. 5, forming a coalesced IP packet 500 from a plurality (N) of data packets may include obtaining the L3 (IP) header 502 of the first data packet of the plurality of data packets, appending the L4 (TCP) header 504 of the first data packet of the N data packets to the L3 header 502, and appending the data (payload) 506 of the first data packet of the N data packets to the L3 and L4 headers 502 and 504. The data (payloads) 508 of the remaining N−1 data packets of the N data packets may be appended to the first packet's data (payload) 506. That is, the data (payload) of all N packets are aggregated together to form the data (payload) of the coalesced IP packet 500. As the L3 and L4 header information is the same for all of the N data packets, the L3 and L4 header information need only be included once in the coalesced IP packet 500, and the L3 and L4 header information can be obtained from the first of the N data packets, for example. Stated another way, the L3 and L4 headers can be stripped from the remaining N−1 data packets, leaving only the data (payloads), which can then be aggregated together to form the data (payload) 508 of the coalesced IP packet 500.

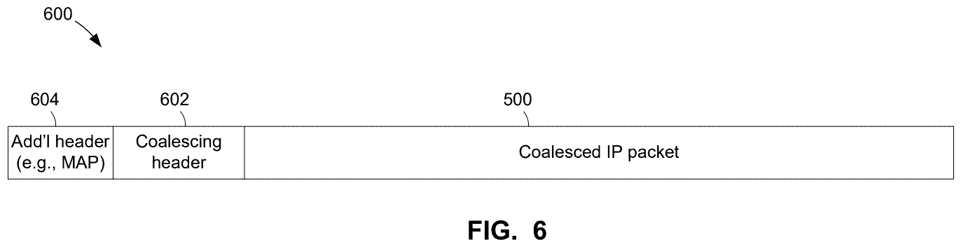

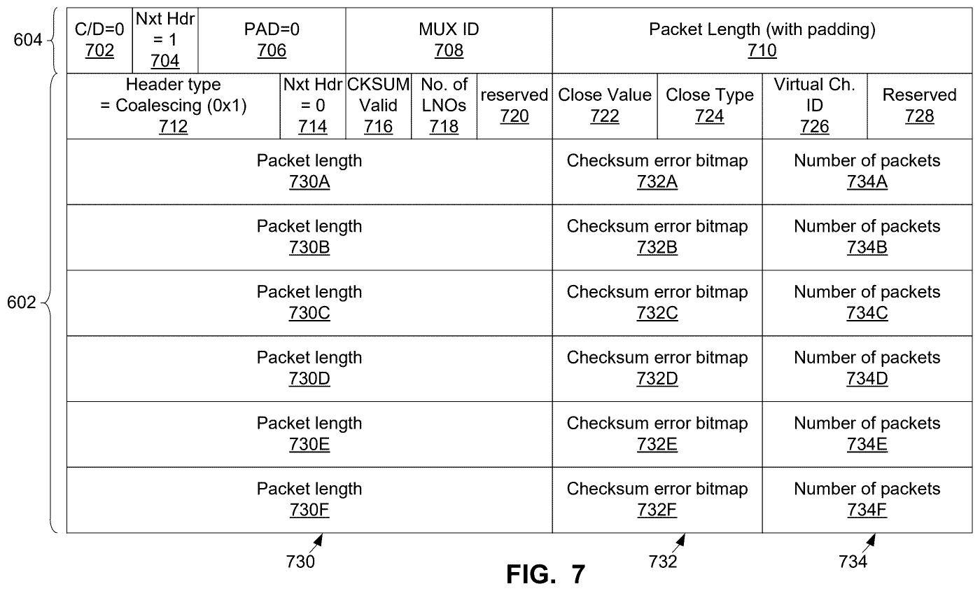

As shown in FIG. 6, a coalesced packet 600 may further include a coalescing header 602 and one or more additional headers 604 appended to the head of the above-described (FIG. 5) coalesced IP packet 500. Examples of these headers 602 and 604 are described below with regard to FIG. 7.

As shown in FIG. 7, the additional header 604 may be, for example, a multiplexing and aggregation protocol (MAP) header. A MAP header may be used in control (i.e., non-IP) packets or for IP data packets. A Control/Data (C/D) field 702 (one bit) may be set to “0” to indicate the packet is a data packet and not a control packet. The MAP header 604 may also have a Next Header field 704 (one bit), which may be set to “1” to indicate that another header (in this example, the coalescing header 602) follows the MAP header 604. Some portions of a header, such as the portion 706, may be padded with zeroes (i.e., contain no information). A Multiplexer Identification (MUX ID) field 708 may contain information indicating to which of a number of packet delivery networks (PDNs) in the receiving device the coalesced data packet is destined. A Packet Length field 710 may contain a number indicating the total length of the coalesced data packet.

The coalescing header 602 may include a Header Type field 712, which may be set to a value (e.g., 0x1) indicating that this header is a coalescing header. The coalescing header 602 may also include a Next Header field 714 (one bit), which may be set to a value of “0” to indicate that no further header follows this header. Note that the above-described TCP/IP headers are included in the coalesced IP packet 500 (FIG. 6) that follows or is appended to the MAP header 604 and coalescing header 602.

A Checksum Valid field 716 (one bit) may be set to “1” to indicate that all packets have a valid transport layer checksum or set to “0” to indicate that at least one packet has an invalid transport layer checksum. A Number of LNOs field 718 may be set to a value indicating the number of entries in the coalescing header, where each entry consists of a packet length 730, checksum error bitmap 732, and number of packets 734. In the illustrated example, there are six such entries: a first entry consisting of a packet length 730A, a corresponding checksum error bitmap 732A, and a corresponding number of packets 734A; a second entry consisting of a packet length 730B, a corresponding checksum error bitmap 732B, and a corresponding number of packets 734B; a third entry consisting of a packet length 730C, a corresponding checksum error bitmap 732C, and a corresponding number of packets 734C; a fourth entry consisting of a packet length 730D, a corresponding checksum error bitmap 732D, and a corresponding number of packets 734D; a fifth entry consisting of a packet length 730E, a corresponding checksum error bitmap 732E, and a corresponding number of packets 734E; and a sixth entry consisting of a packet length 730F, a corresponding checksum error bitmap 732F, and a corresponding number of packets 734F. In each entry the number of packets 734 indicates how many packets of the corresponding packet length 730 are included in the data (payload) that follows the headers in the coalesced packet. The packet length 730 may be the sum of the lengths of the L3 header, the L4 header and the data that follows the L3 and LA headers. Although in the illustrated example there are six such entries, in other examples there may be any number of such entries. A field 720 may be reserved for uses that are not relevant to the solutions described herein.

The coalescing header 602 may further include a Close Type field 722 containing information relating to when to stop or close the coalescing (aggregation) operation. For example, the field 722 may contain a value indicating to stop coalescing when the aggregation reaches a limit based on the total of the packet lengths 730 and number of packets 734. In another example, the field 722 may contain a value indicating to stop coalescing when a time limit is reached. A Virtual Channel Identifier field 726 may contain a value that may be used to differentiate multiple virtual endpoint event completions that are multiplexed over the same event ring. The value refers to the number of TCP streams that can be coalesced simultaneously in parallel. Another field 728 may be reserved for uses that are not relevant to the solutions described herein.

Another aspect of the solutions described herein may relate to determining when to stop coalescing. If data traffic from the data source to the coalescing logic or circuitry is slow, it may take a substantial amount of time to aggregate a fixed or constant number (N) of packets. A long aggregation time may increase end-to-end delay between the first (coalescing) device and the second (de-coalescing) device. For these reasons, it may be desirable to determine a coalesced packet payload size dynamically instead of using a fixed number N.

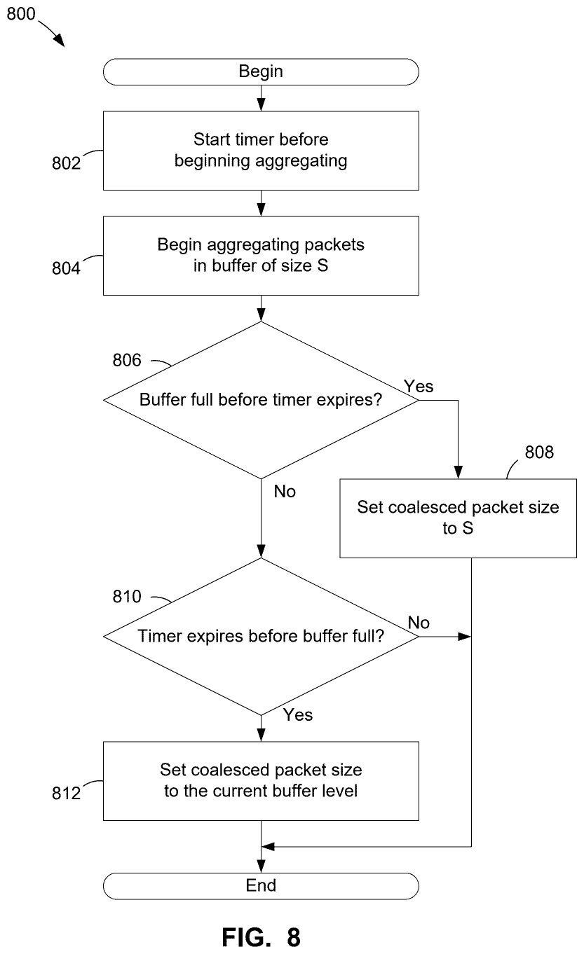

In FIG. 8, a method 800 for adjusting the size of the payload of a coalesced data packet is shown in flow diagram form. As a result of the method 800, the above-referenced number N of packets that are coalesced may variable or adjustable. That is, different coalesced data packets may have different sizes. The method 800 may be performed in combination with the above-described method 400 to dynamically adjust the size of the coalesced data packets that are transmitted over the data link. Although the method 800 is described in the form of blocks indicating various operations in an order conducive to understanding an example, it should be understood that operations may be combined or split, may occur in other orders or concurrently, may be omitted in whole or part, or may be combined with additional operations not described herein.

As indicated by block 802, a timer may be started before beginning aggregating data packets. For example, the timer may be set to time a 5 ms interval.

As indicated by block 804, packets received from a data source may be aggregated in a buffer of size S, where S represents a number of packets. For example, the buffer may have a size of 64K bytes (S=64K).

As indicated by block 806, it may be determined whether the buffer becomes full before the timer expires. In an example in which the timer interval is 5 ms and the buffer size is 64k, it may be determined whether 64k bytes are received for aggregation within 5 ms. If it is determined (block 806) that the buffer has become full before the timer has expired, then the coalesced data packet size may be set to S, as indicated by block 808. That is, S may be used as the above-described value N for that coalesced data packet.

As indicated by block 810, it may be determined whether the timer expires before the buffer becomes full. If it is determined that the timer has expires before the buffer has become full, then the coalesced packet size may be set to the number of packets then in the buffer (i.e., the then-current buffer level), as indicated by block 812. For example, if 40k packets have been received in a buffer of size 64k when the timer expires, then the coalesced packet size may be set to 40k.

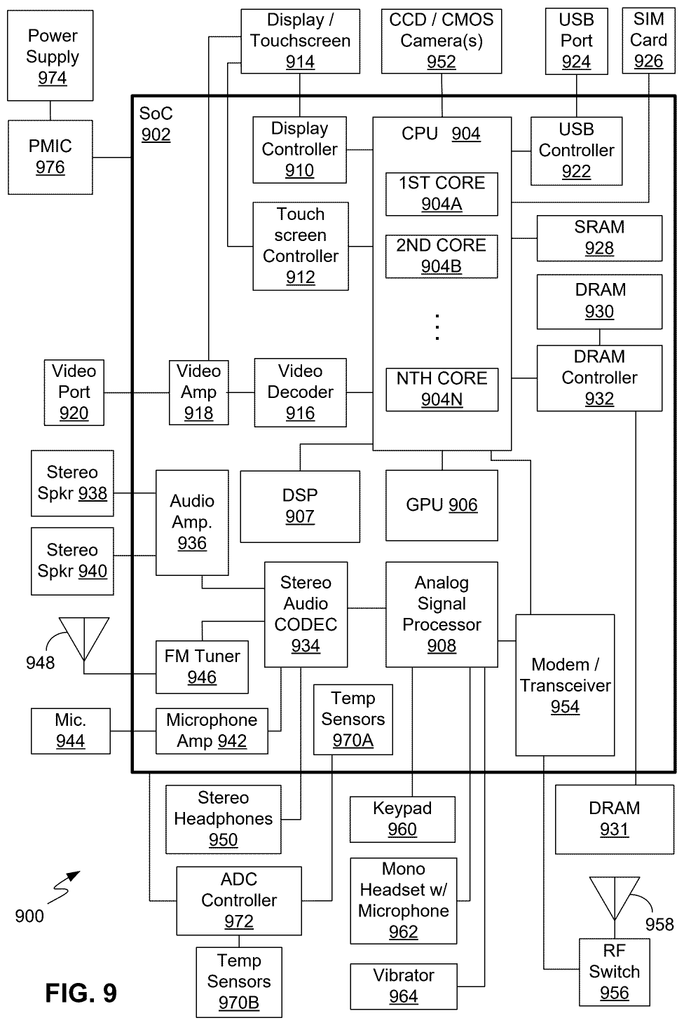

FIG. 9 illustrates an example of a portable computing device (PCD) 900, in which exemplary embodiments of systems, methods, and other examples of communicating data from a first device to a second device over a data link may be provided. The PCD 900 may be, for example, a laptop or palmtop computer, cellular telephone or smartphone, personal digital assistant, navigation device, smartbook, portable game console, satellite telephone, automotive device, Internet-of-Things (IoT) device, etc. For purposes of clarity, some data buses, interconnects, signals, etc., are not shown in FIG. 9.

The PCD 900 may include an SoC 902. The SoC 902 may include a CPU 904, a GPU 906, a digital signal processor (DSP) 907, an analog signal processor 908, a modem/modem subsystem 954, or other processors. Any of such processors or subsystems may be interconnected by one or more data links and may provide data packet coalescing and de-coalescing in the manner described above. That is, any of such processors or subsystems that are configured to transmit data over a data link may include coalescing circuitry, configured as described above. Any of such processors or subsystems that are configured to receive data over a data link may include de-coalescing circuitry, configured as described above. The CPU 904 may include one or more CPU cores, such as a first CPU core 904A, a second CPU core 904B, etc., through an Nth CPU core 904N.

A display controller 910 and a touch-screen controller 912 may be coupled to the CPU 904. A touchscreen display 914 external to the SoC 902 may be coupled to the display controller 910 and the touch-screen controller 912. The PCD 900 may further include a video decoder 916 coupled to the CPU 904. A video amplifier 918 may be coupled to the video decoder 916 and the touchscreen display 914. A video port 920 may be coupled to the video amplifier 918. A universal serial bus (USB) controller 922 may also be coupled to CPU 904, and a USB port 924 may be coupled to the USB controller 922. A subscriber identity module (SIM) card 926 may also be coupled to the CPU 904.

The CPU 904 may be coupled to one or more memories, with which the CPU 904 may initiate memory transactions. The one or more memories may include both volatile and non-volatile memories or NVMs. Examples of volatile memories include static random access memory (RAM) 928 and dynamic random access memory (DRAM) 930 and 931. Such memories may be internal to the SoC 902, as in the case of the DRAM 930, or external to the SoC, as in the case of the DRAM 931. A DRAM controller 932 coupled to the CPU 904 may control the writing of data to, and reading of data from, the DRAMs 930 and 931.

A stereo audio CODEC 934 may be coupled to the analog signal processor 908. Further, an audio amplifier 936 may be coupled to the stereo audio CODEC 934. First and second stereo speakers 938 and 940, respectively, may be coupled to the audio amplifier 936. In addition, a microphone amplifier 942 may be coupled to the stereo audio CODEC 934, and a microphone 944 may be coupled to the microphone amplifier 942. A frequency modulation (FM) radio tuner 946 may be coupled to the stereo audio CODEC 934. An FM antenna 948 may be coupled to the FM radio tuner 946. Further, stereo headphones 950 may be coupled to the stereo audio CODEC 934.

Other devices that may be coupled to the CPU 904 include one or more digital (e.g., CCD or CMOS) cameras 952. An example of real-time operation, to which the D2D link maintenance control solutions described herein may apply, is capturing video images using the cameras 952 and then processing the images as they are captured (i.e., in a real-time or streaming manner) using, for example, the GPU 906 and CPU 904. The methods and systems for controlling a D2D communication link to provide maintenance downtime may be used where, for example, the GPU 906 and CPU 904 are on different dies or chiplets that are coupled by such a D2D link.

The RF transceiver or modem subsystem 954 may be coupled to the analog signal processor 908 and the CPU 904. An RF switch 956 may be coupled to the modem subsystem 954 and an RF antenna 958. In addition, a keypad 960, a mono headset with a microphone 962, and a vibrator device 964 may be coupled to the analog signal processor 908.

The SoC 902 may have one or more internal or on-chip thermal sensors 970A and may be coupled to one or more external or off-chip thermal sensors 970B. An analog-to-digital converter controller 972 may convert voltage drops produced by the thermal sensors 970A and 970B to digital signals. A power supply 974 and a power management integrated circuit (PMIC) 976 may supply power to the SoC 902.

Implementation examples are described in the following numbered clauses.

1. A method for communicating data from a first device to a second device over a data link, comprising:
receiving, by the first device, a plurality of data packets from a data source associated with the first device;
providing, by the first device, first header information based on at least one data packet of the plurality of data packets;
sending, by the first device, the first header information to the second device over the data link;
providing a coalesced data packet, including aggregating, by the first device, the plurality of data packets into a payload of the coalesced data packet; and
sending, by the first device, the coalesced data packet to the second device over the data link, wherein sending the first header information is performed before aggregating the plurality of data packets is completed.

2. The method of clause 1, wherein:
providing the first header information comprises providing a Transport Control Protocol (TCP) header and an Internet Protocol (IP) header; and
sending the first header information comprises sending the TCP header and the IP header.

3. The method of clause 1 or 2, wherein the providing the coalesced data packet includes providing second header information comprising a coalescing header.

4. The method of any of clauses 1-3, further comprising adjusting a size of the payload of the coalesced data packet.

5. The method of clause 4, wherein adjusting the size of the payload of the coalesced data packet comprises:
measuring a time interval during which all remaining data packets are received; and
adjusting the size of the payload of the coalesced data packet based on a measured time interval.

6. The method of clause 5, further comprising:
setting a timer when beginning receiving the plurality of data packets;
buffering the data packets in a buffer having a buffer size;
setting the size of the payload of the coalesced data packet to the buffer size if a buffer fill level reaches the buffer size before the timer expires; and
setting the size of the payload of the coalesced data packet to the buffer fill level if the timer expires before the buffer fill level reaches the buffer size.

7. The method of any of clauses 1-6, wherein the first device comprises a modem chip, and the second device comprises a host processor chip.

8. A system for communicating data from a first device to a second device over a data link, comprising:
a data packet buffer in the first device configured to receive a plurality of data packets from a data source associated with the first device;
header processing circuitry in the first device configured to provide first header information based on at least one data packet of the plurality of data packets and further configured to send the first header information to the second device over the data link; and
aggregator circuitry in the first device configured to provide a coalesced data packet, the aggregator circuitry configured to aggregate the plurality of data packets into a payload of the coalesced data packet and to send the coalesced data packet to the second device over the data link, wherein the header processing circuitry is configured to send the first header information before the aggregator circuitry completes aggregating the plurality of data packets.

9. The system of clause 8, wherein the first header information comprises a Transport Control Protocol (TCP) header and an Internet Protocol (IP) header, and the header processing circuitry is configured to send the TCP header and the IP header.

10. The system of clause 8 or 9, wherein the aggregator circuitry is configured to provide second header information comprising a coalescing header in the coalesced data packet.

11. The system of any of clauses 8-10, wherein the aggregator circuitry is configured to adjust a size of the payload of the coalesced data packet.

12. The system of clause 11, wherein the aggregator circuitry is configured to adjust the size of the payload of the coalesced data packet by being configured to:
measure a time interval during which all remaining data packets are received; and
adjust the size of the payload of the coalesced data packet based on a measured time interval.

13. The system of clause 12, wherein the aggregator circuitry is configured to:
set a timer when beginning receiving the plurality of data packets;
buffering the data packets in a buffer having a buffer size;
set the size of the payload of the coalesced data packet to the buffer size if a buffer fill level reaches the buffer size before the timer expires; and
set the size of the payload of the coalesced data packet to the buffer fill level if the timer expires before the buffer fill level reaches the buffer size.

14. The system of any of clauses 8-13, wherein the first device comprises a modem chip, and the second device comprises a host processor chip.

15. A system for communicating data from a first device to a second device over a data link, comprising:
coalescing circuitry in the first device configured to aggregate a plurality of data packets into a payload of a coalesced data packet, to send a Transport Control Protocol (TCP) header of the coalesced data packet to the second device over the data link, and to send the coalesced data packet to the second device over the data link after sending the TCP header; and
de-coalescing circuitry in the second device configured to process the TCP header before receiving the coalesced data packet from the first device and to de-aggregate the payload of the coalesced data packet using the TCP header.

16. The system of clause 15, wherein:
the coalescing circuitry in the first device is configured to send an Internet Protocol (IP) header with the TCP header of the coalesced data packet to the second device over the data link; and
the de-coalescing circuitry in the second device is configured to process the IP header before receiving the coalesced data packet from the first device.

17. The system of clause 15 or 16, wherein the coalescing circuitry is configured to provide a coalescing header in the coalesced data packet.

18. The system of any of clauses 15-17, wherein the coalescing circuitry is configured to adjust a size of the payload of the coalesced data packet.

19. The system of clause 18, wherein the coalescing circuitry is configured to adjust the size of the payload of the coalesced data packet by being configured to:
measure a time interval during which all remaining data packets are received; and
adjust the size of the payload of the coalesced data packet based on a measured time interval.

20. The system of clause 19, wherein the coalescing circuitry is configured to:
set a timer when beginning receiving the plurality of data packets;
buffering the data packets in a buffer having a buffer size;
set the size of the payload of the coalesced data packet to the buffer size if a buffer fill level reaches the buffer size before the timer expires; and
set the size of the payload of the coalesced data packet to the buffer fill level if the timer expires before the buffer fill level reaches the buffer size.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A method for communicating data from a first device to a second device over a data link, comprising:
receiving, by the first device, a plurality of data packets from a data source associated with the first device;
providing, by the first device, first header information based on at least one data packet of the plurality of data packets;
sending, by the first device, the first header information to the second device over the data link;
providing a coalesced data packet, including aggregating, by the first device, the plurality of data packets into a payload of the coalesced data packet; and
sending, by the first device, the coalesced data packet to the second device over the data link, wherein sending the first header information is performed before aggregating the plurality of data packets is completed.

2. The method of claim 1, wherein:
providing the first header information comprises providing a Transport Control Protocol (TCP) header and an Internet Protocol (IP) header; and
sending the first header information comprises sending the TCP header and the IP header.

3. The method of claim 1, wherein the providing the coalesced data packet includes providing second header information comprising a coalescing header.

4. The method of claim 1, further comprising adjusting a size of the payload of the coalesced data packet.

5. The method of claim 4, wherein adjusting the size of the payload of the coalesced data packet comprises:
measuring a time interval during which all remaining data packets are received; and
adjusting the size of the payload of the coalesced data packet based on a measured time interval.

6. The method of claim 5, further comprising:
setting a timer when beginning receiving the plurality of data packets;
buffering the data packets in a buffer having a buffer size;
setting the size of the payload of the coalesced data packet to the buffer size if a buffer fill level reaches the buffer size before the timer expires; and
setting the size of the payload of the coalesced data packet to the buffer fill level if the timer expires before the buffer fill level reaches the buffer size.

7. The method of claim 1, wherein the first device comprises a modem chip, and the second device comprises a host processor chip.

8. A system for communicating data from a first device to a second device over a data link, comprising:
a data packet buffer in the first device configured to receive a plurality of data packets from a data source associated with the first device;
header processing circuitry in the first device configured to provide first header information based on at least one data packet of the plurality of data packets and further configured to send the first header information to the second device over the data link; and
aggregator circuitry in the first device configured to provide a coalesced data packet, the aggregator circuitry configured to aggregate the plurality of data packets into a payload of the coalesced data packet and to send the coalesced data packet to the second device over the data link, wherein the header processing circuitry is configured to send the first header information before the aggregator circuitry completes aggregating the plurality of data packets.

9. The system of claim 8, wherein the first header information comprises a Transport Control Protocol (TCP) header and an Internet Protocol (IP) header, and the header processing circuitry is configured to send the TCP header and the IP header.

10. The system of claim 8, wherein the aggregator circuitry is configured to provide second header information comprising a coalescing header in the coalesced data packet.

11. The system of claim 8, wherein the aggregator circuitry is configured to adjust a size of the payload of the coalesced data packet.

12. The system of claim 11, wherein the aggregator circuitry is configured to adjust the size of the payload of the coalesced data packet by being configured to:
measure a time interval during which all remaining data packets are received; and
adjust the size of the payload of the coalesced data packet based on a measured time interval.

13. The system of claim 12, wherein the aggregator circuitry is configured to:
set a timer when beginning receiving the plurality of data packets;
buffering the data packets in a buffer having a buffer size;
set the size of the payload of the coalesced data packet to the buffer size if a buffer fill level reaches the buffer size before the timer expires; and
set the size of the payload of the coalesced data packet to the buffer fill level if the timer expires before the buffer fill level reaches the buffer size.

14. The system of claim 8, wherein the first device comprises a modem chip, and the second device comprises a host processor chip.

15. A system for communicating data from a first device to a second device over a data link, comprising:
coalescing circuitry in the first device configured to aggregate a plurality of data packets into a payload of a coalesced data packet, to send a Transport Control Protocol (TCP) header of the coalesced data packet to the second device over the data link, and to send the coalesced data packet to the second device over the data link after sending the TCP header; and
de-coalescing circuitry in the second device configured to process the TCP header before receiving the coalesced data packet from the first device and to de-aggregate the payload of the coalesced data packet using the TCP header.

16. The system of claim 15, wherein:
the coalescing circuitry in the first device is configured to send an Internet Protocol (IP) header with the TCP header of the coalesced data packet to the second device over the data link; and
the de-coalescing circuitry in the second device is configured to process the IP header before receiving the coalesced data packet from the first device.

17. The system of claim 15, wherein the coalescing circuitry is configured to provide a coalescing header in the coalesced data packet.

18. The system of claim 15, wherein the coalescing circuitry is configured to adjust a size of the payload of the coalesced data packet.

19. The system of claim 18, wherein the coalescing circuitry is configured to adjust the size of the payload of the coalesced data packet by being configured to:
measure a time interval during which all remaining data packets are received; and
adjust the size of the payload of the coalesced data packet based on a measured time interval.

20. The system of claim 19, wherein the coalescing circuitry is configured to:
set a timer when beginning receiving the plurality of data packets;
buffering the data packets in a buffer having a buffer size;
set the size of the payload of the coalesced data packet to the buffer size if a buffer fill level reaches the buffer size before the timer expires; and
set the size of the payload of the coalesced data packet to the buffer fill level if the timer expires before the buffer fill level reaches the buffer size.
